(19) United States
(12) Patent Application Publication
(10) Pub. No.: US 2025/0384838 A1
(43) Pub. Date: Dec. 18, 2025

(54) DISPLAY DEVICE INCLUDING DISPLAY PANEL, OPERATING METHOD THEREOF, AND DISPLAY SYSTEM INCLUDING THE SAME

(71) Applicant: Samsung Display Co., Ltd., Yongin-si (KR)

(72) Inventors: Jong Man KIM, Yongin-si (KR); Jai Hyun KOH, Yongin-si (KR); Seung Ho PARK, Yongin-si (KR); Byoung Kwan AN, Yongin-si (KR); Joon Hyeok JEON, Yongin-si (KR); Sang Myeon HAN, Yongin-si (KR)

(21) Appl. No.: 19/219,792

(22) Filed: May 27, 2025

(30) Foreign Application Priority Data
Jun. 18, 2024 (KR) 10-2024-0078844
Aug. 6, 2024 (KR) 10-2024-0104716

(51) Int. Cl. G09G 3/3258; G09G 3/32

(52) U.S. Cl. CPC G09G 3/3258; G09G 3/32; G09G 2320/043; G09G 2320/0626; G09G 2320/0666

(57) ABSTRACT

A display device includes: a display panel including display areas; a controller configured to control display a video through the display panel based on video frames being sequentially provided, each of the video frames including video data blocks corresponding to the display areas, respectively; and an indicator generator configured to generate a block indicator having a value that is changed based on power-on being performed, wherein the controller is configured to: select the video data block that is indicated by the block indicator from the video data blocks of the video frame that is first provided among the video frames, and update an accumulative stress data set of the corresponding display area based on the selected video data block of the video frame.

### CROSS-REFERENCE TO RELATED APPLICATION

The present application claims priority to and the benefit of Korean Patent Application No. 10-2024-0078844, filed on Jun. 18, 2024, in the Korean Intellectual Property Office, and Korean Patent Application No. 10-2024-0104716 filed on Aug. 6, 2024, in the Korean Intellectual Property Office, the entire disclosures of each of which are incorporated herein by reference.

### BACKGROUND

### 1. Field

Aspects of some embodiments of the present disclosure relate to display device including a display panel, an operating method thereof, and a display system including the same.

### 2. Description of the Related Art

A display device may be driven at a relatively fast response speed with relatively low power consumption by using light-emitting diodes (LEDs) or organic light-emitting diodes (OLEDs) that generate light through recombination of electrons and holes.

The light-emitting luminance of a display device is determined depending on a driving current that flows through light-emitting diodes of each pixel. A high-luminance image may require a driving current that is larger than the driving current of a low-luminance image.

Each pixel may be stressed depending on the driving current, and such stress may deteriorate the pixel. The more stressed a pixel is, the more it may be deteriorated, and the deteriorated pixel may emit light of reduced luminance in response to data of the same gray scale. This may cause deterioration of the display quality.

Through the use of an image sticking compensation technology, it may be possible to remove the image sticking by accumulating the stress (or the degree of deterioration) corresponding to the pixel and performing compensation for a data voltage being applied to the pixel based on the accumulated data

The above-described contents are only to help understanding of a background technology for the technical ideas of the present disclosure, and thus they are unable to be understood as the contents corresponding to the prior art technology known to those skilled in the technical fields of the present disclosure.

### SUMMARY

Aspects of some embodiments of the present disclosure include a display device having relatively improved reliability and an operating method thereof. For example, a display device may accumulate stress data sets corresponding to display areas with relatively improved reliability, and may perform compensation for a data voltage that is applied to a pixel based on the accumulative stress data sets. Accordingly, image sticking may be effectively removed from an image that is displayed on a display panel.

A display device according to some embodiments of the present disclosure includes: a display panel including display areas; a controller to display a video through the display panel based on video frames being sequentially provided, each of the video frames including video data blocks corresponding to the display areas, respectively; and an indicator generator to generate a block indicator having a value that is changed whenever power-on is performed. According to some embodiments, the controller is configured to: select the video data block that is indicated by the block indicator from the video data blocks of the video frame that is first provided among the video frames, and update an accumulative stress data set of the corresponding display area based on the selected video data block of the video frame.

According to some embodiments, the block indicator may indicate any one of the video data blocks.

According to some embodiments, the indicator generator may include a counter to generate a count value that is changed whenever the power-on is performed within a predetermined numerical range, wherein the count value may be provided as the block indicator.

According to some embodiments, the indicator generator may include a random number generator to generate a random number within a predetermined numerical range whenever the power-on is performed, wherein the random number may be provided as the block indicator.

According to some embodiments, the indicator generator may include: a counter to generate a count value that is changed whenever the power-on is performed within a predetermined numerical range; a random number generator to generate a random number within the numerical range whenever the power-on is performed; and a selector to provide any one of the count value or the random number to the block indicator.

According to some embodiments, the display areas may include first to m-th (where, m is an integer that is larger than 1) display areas, the video frames may include first to m-th video frames that are sequentially provided after the power-on, the video data blocks included in each of the first to m-th video frames may include first to m-th video data blocks corresponding to the first to m-th display areas, respectively, and the video frame that is first provided among the video frames may be the first video frame.

According to some embodiments, the block indicator may indicate the k-th (where, k is an integer that is larger than or equal to 1 and smaller than or equal to m) video data block among the first to m-th video data blocks.

According to some embodiments, in case that the block indicator indicates any one of the second to (m−1)-th video data blocks, the controller may be configured to: select the k-th to m-th video data blocks and the first to (k−1)-th video data blocks from the first to m-th video frames, and update k-th to m-th accumulative stress data sets and first to (k−1)-th accumulative stress data sets corresponding to the k-th to m-th display areas and the first to (k−1)-th display areas based on the k-th to m-th video data blocks and the first to (k−1)-th video data blocks, respectively.

According to some embodiments, in case that the block indicator indicates the m-th video data block, the controller may be configured to: select the m-th video data block and the first to (m−1)-th video data blocks from the first to m-th video frames, and update an m-th accumulative stress data set and first to (m−1)-th accumulative stress data sets corresponding to the m-th display area and the first to (m−1)-th display areas based on the m-th video data block and the first to (m−1)-th video data blocks, respectively.

According to some embodiments, in case that the block indicator indicates the first video data block, the controller may be configured to: select the first to m-th video data blocks from the first to m-th video frames, and update first to m-th accumulative stress data sets corresponding to the first to m-th display areas based on the first to m-th video data blocks, respectively.

According to some embodiments, the controller may be configured to: extract a different video data block among the video data blocks from the respective video frames, and update the accumulative stress data set corresponding to the corresponding display area based on the different video data block.

According to some embodiments, the video frames may be video frames that are first provided after the power-on.

According to some embodiments, the display device may further include: a working memory connected to the controller; and a nonvolatile memory connected to the controller. The controller may be configured to: update the accumulative stress data set in the working memory, and store the accumulative stress data set of the working memory on the nonvolatile memory in a predetermined period of time.

According to some embodiments of the present disclosure, in an operating method of a display device including display areas, the operating method includes: generating a block indicator having a value that is changed whenever power-on is performed; receiving video frames being sequentially provided and to be displayed on the display device as a video, each of the video frames including video data blocks corresponding to the display areas, respectively; selecting the video data block that is indicated by the block indicator from the video data blocks of the video frame that is first provided among the video frames; and updating an accumulative stress data set of the corresponding display area based on the selected video data block of the video frame.

According to some embodiments, generating the block indicator may include: generating a count value that is changed whenever the power-on is performed within a predetermined numerical range; and providing the count value as the block indicator.

According to some embodiments, generating the block indicator may include: generating a random number within a predetermined numerical range whenever the power-on is performed; and providing the random number as the block indicator.

According to some embodiments, generating the block indicator may include: generating a count value that is changed whenever the power-on is performed within a predetermined numerical range; generating a random number within the predetermined numerical range whenever the power-on is performed; and providing any one of the count value or the random number to the block indicator.

According to some embodiments, the operating method may further include: extracting next video data blocks of the video data block that is indicated by the block indicator from next video frames of the video frame that is first provided among the video frames; and updating the accumulative stress data sets of the corresponding display areas based on the extracted video data blocks.

According to some embodiments of the present disclosure, a display system includes: a processor; and a display device to receive video frames from the processor and to display a video based on the video frames. According to some embodiments, the display device includes: a display panel including display areas; a controller to control the display panel to display the video based on the video frames, each of the video frames including video data blocks corresponding to the display areas, respectively; and an indicator generator to generate a block indicator having a value that is changed whenever power-on is performed. According to some embodiments, the controller is configured to: select the video data block that is indicated by the block indicator from the video data blocks of the video frame that is first provided among the video frames, and update an accumulative stress data set of the corresponding display area based on the selected video data block of the video frame.

According to some embodiments of the present disclosure, a display device having relatively improved reliability and an operating method thereof are provided.

The characteristics of embodiments according to the present disclosure are not limited by the characteristics described above, and various other characteristics are included in the present specification.

### BRIEF DESCRIPTION OF THE DRAWINGS

FIG. 1 is a block diagram showing a display device according to some embodiments of the present disclosure.

FIG. 2 is a graph showing changes in luminance of a display panel according to an accumulative stress that is applied to the display panel of FIG. 1.

FIG. 3 is a block diagram showing aspects of a control board of FIG. 1.

FIG. 4 is a diagram showing an example of processes of updating first to m-th accumulative stress data sets based on first to m-th reference video frames.

FIG. 5 is a diagram conceptually showing the relationship between display areas of the display panel of FIG. 1 and video data blocks of a reference video frame.

FIG. 6 is a diagram conceptually showing processes of updating first to q-th accumulative stress data sets based on first to q-th frame groups.

FIG. 7 is a block diagram showing aspects of an indicator generator of FIG. 3 according to some embodiments.

FIG. 8 is a block diagram showing further details of an indicator generator of FIG. 3 according to some embodiments.

FIG. 9 is a block diagram showing further details of an indicator generator of FIG. 3 according to some embodiments.

FIG. 10 is a diagram showing aspects of processes of updating first to m-th accumulative stress data sets based on first to m-th reference video frames.

FIG. 11 is a diagram showing aspects of processes of updating first to m-th accumulative stress data sets based on first to z-th frame groups.

FIGS. 12 and 13 are block diagrams showing display areas that may be separated in various ways according to some embodiments.

FIG. 14 is a block diagram showing aspects of a control board of FIG. 1 according to some embodiments.

FIG. 15 is a diagram conceptually showing an accumulative stress value and a compensatory stress value.

FIG. 16 is a block diagram showing aspects of a deterioration compensation logic of FIG. 14 according to some embodiments.

FIG. 17 is a flowchart showing aspects of a method for storing first to m-th accumulative stress data sets in a nonvolatile memory according to some embodiments.

FIG. 18 is a flowchart showing further details of the operation S130 of FIG. 17.

FIG. 19 is a flowchart showing further details of the operation S120 of FIG. 17.

FIG. 20 is a flowchart showing further details of the operation S120 of FIG. 17.

FIG. 21 is a flowchart showing further details of the operation S120 of FIG. 17.

FIG. 22 is a block diagram showing a display system according to some embodiments of the present disclosure.

### DETAILED DESCRIPTION

Hereinafter, aspects of some embodiments according to the present disclosure will be described in detail with reference to the accompanying drawings. In the following description, it is to be noted that only parts needed to understand the operation according to the present disclosure will be described, and description of other parts will be omitted to avoid obscuring the gist of the present disclosure. In addition, the present disclosure is not limited to the embodiments described herein, and may be embodied in different forms. The embodiments described herein are provided for the purpose of describing the technical idea of the present disclosure in sufficient detail for those of ordinary skill in the art to which the present disclosure pertains to easily carry out the technical idea of the present disclosure.

Throughout the specification, when it is described that an element is “connected” to another element, this includes not only being “directly connected”, but also being “indirectly connected” to each other with still another element interposed therebetween. The terms used herein are for the purpose of describing specific embodiments and are not intended to limit the scope of the present disclosure. Throughout the specification, unless specifically described to the contrary, the word “include” and variations such as “includes” or “including” will be understood to imply the inclusion of stated elements but not the exclusion of any other elements. The terms “at least one of X, Y, and Z” and “at least one selected from the group consisting of X, Y, and Z” may be construed as X only, Y only, Z only, or any combination of two or more of X, Y, and Z (e.g., XYZ, XYY, YZ, and ZZ). As used herein, the term “and/or” includes any one or all combinations of one or more of corresponding configurations.

Although the terms “first, second, and so on” may be used herein to describe various constituent elements, these constituent elements should not be limited by these terms. These terms are used to distinguish one constituent element from another. Thus, a first constituent element discussed below can be called a second constituent element without departing from the teachings of the present disclosure.

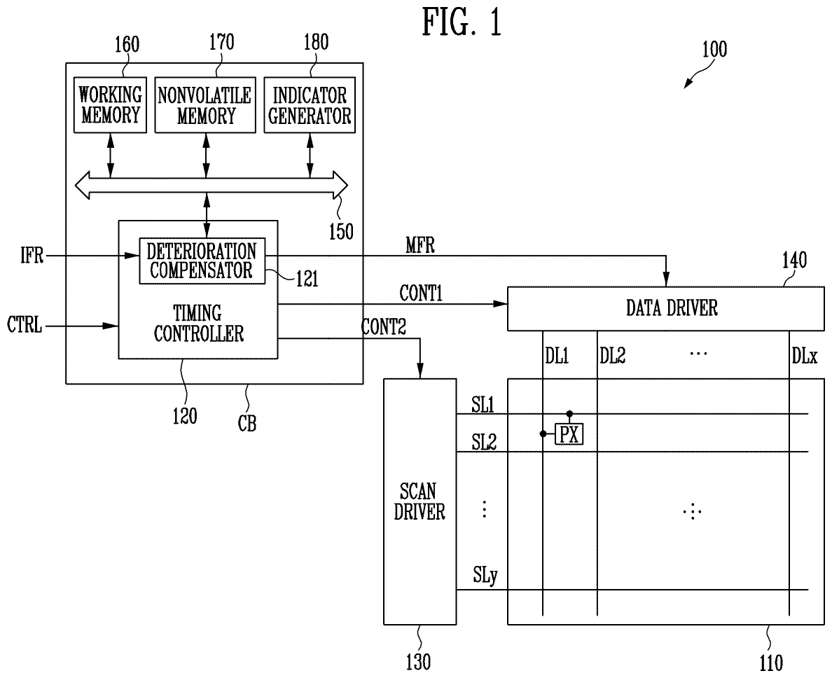

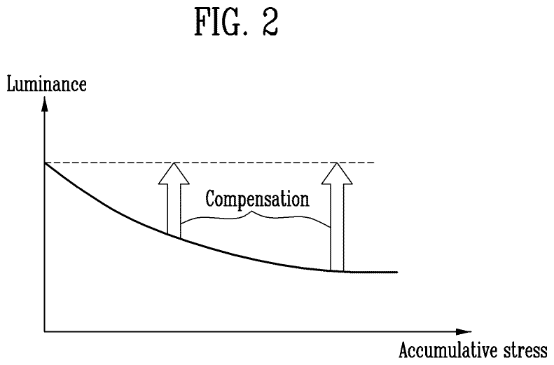

FIG. 1 is a block diagram showing a display device according to some embodiments of the present disclosure. FIG. 2 is a graph showing changes in luminance of a display panel according to an accumulative stress that is applied to the display panel of FIG. 1.

Referring to FIG. 1, a display device 100 includes a display panel 110, a timing controller 120, a scan driver 130, and a data driver 140.

The display panel 110 includes pixels PX. The pixels PX are connected to the scan driver 130 through first to y-th scan lines SL1 to Sly, and are connected to the data driver 140 through first to x-th data lines DL1 to DLx.

Each of the pixels PX may include a light-emitting element and transistors for driving the light-emitting element. According to some embodiments, the light-emitting element may include an organic light-emitting diode and/or an inorganic light-emitting diode configured to emit light of a specific color. For example, each pixel may be any one of a red sub-pixel, a green sub-pixel, or a blue sub-pixel.

The timing controller 120 controls the overall operation of the display device 100. The timing controller 120 receives an input video frame IFR and control signals CTRL for controlling the display thereof, for example, a vertical synchronization signal, a horizontal synchronization signal, a main clock signal, and a data enable signal.

According to some embodiments of the present disclosure, the timing controller 120 includes a deterioration compensator 121. The deterioration compensator 121 may be configured to estimate a stress being applied to the pixels PX depending on the operation of the display panel 110, and to generate a modified video frame MFR by compensating for the input video frame IFR depending on the estimated stress.

The timing controller 120 may change the data format and/or arrangement of the modified video frame MFR to fit the display panel 110 based on the control signals CTRL, and may perform various processes with respect to the modified video frame MFR, such as timing adjustment of the modified video frame MFR. The timing controller 120 display a video on the display panel 110 by providing the modified video frame MFR of which the processes have been performed to the data driver 140.

The timing controller 120 may transmit a first control signal CONT1 to the data driver 140 and may transmit a second control signal CONT2 to the scan driver 130 based on the control signals CTRL. According to some embodiments, the first control signal CONT1 may include a clock signal and a line latch signal, and the second control signal CONT2 may include a vertical synchronization start signal and an output enable signal.

The scan driver 130 drives the first to y-th scan lines SL1 to SLy in response to the second control signal CONT2 from the timing controller 120. According to some embodiments, the scan driver 130 includes a scan integrated circuit (IC). According to some embodiments, the scan driver 130 may be implemented by a circuit that uses oxide semiconductor, crystalline semiconductor, and polycrystalline semiconductor. The scan driver 130 may be formed simultaneously with the pixels PX.

The data driver 140 may drive the first to x-th data lines DL1 to DLx in response to the first control signal CONT1. The data driver 140 may output gray scale voltages corresponding to the modified video data MFR to the first to x-th data lines DL1 to DLx in response to the first control signal CONT1.

When the scan lines SL1 to SLy are driven by the scan driver 130 with a gate-on voltage, the gray scale voltages corresponding to gray scale values of the modified video data MFR may be applied to the data lines DL1 to DLx. Accordingly, the gray scale voltages corresponding to the modified video data MFR may be provided to the pixels PX, and the pixels PX may output light with luminance corresponding to the gray scale voltages.

As described above, the timing controller 120 may display the video by driving the display panel 110 through the scan driver 130 and the data driver 140.

Referring to FIG. 2, the horizontal axis represents the accumulative stress that is applied to the pixel of the display panel 110 of FIG. 1, and the vertical axis represents the luminance that the corresponding pixel generates in response to the video frame (e.g., MFR of FIG. 1) having the same gray scale value. In FIG. 2, as the stress that is applied to the pixel is accumulated, a luminance drop for the same gray scale value may be intensified. For example, as the accumulative stress increases, the corresponding pixel may gradually deteriorate, and as the pixel deteriorates, the corresponding pixel may output the reduced luminance in response to the same gray scale value.

In consideration of such a luminance drop, compensation for the gray scale value of the video frame may be performed with reference to the accumulative stress, and the pixel may be driven with the corresponding gray scale value. Accordingly, the pixel may output the luminance at a desired level. For example, as the accumulative stress increases, the compensation value that is added to the gray scale value of the video frame may increase as shown as arrows of FIG. 2. In this case, the pixel may output the luminance at a desired level as shown as a dotted line of FIG. 2.

The accumulative stress may be related to the gray scale values having been represented by the pixels. For example, the gray scale values of the video frames having been represented by each pixel may be continuously monitored, and the gray scale values having been represented by the pixel may be accumulated. In accordance with the accumulated data, the accumulative stress may be estimated.

The accumulative data may be loaded into a working memory such as RAM, and may be continuously updated based on each video frame. The accumulative data of the working memory may be periodically stored (or backed up) in a nonvolatile storage medium such as a flash memory.

Referring again to FIG. 1, the display device 100 may further include a bus system 150, a working memory 160, a nonvolatile memory 170, an indicator generator 180, and a power management integrated circuit (PMIC).

The bus system 150 is configured to provide interfaces with the working memory 160, the nonvolatile memory 170, and the indicator generator 180 to the timing controller 120. The deterioration compensator 121 of the timing controller 120 may communicate with the working memory 160, the nonvolatile memory 170, and the indicator generator 180 through the bus system 150.

The deterioration compensator 121 is configured to update an accumulative stress data set corresponding to one of display areas of the display panel 110 in the working memory 160 based on a part of a reference video frame. The deterioration compensator 121 is configured to update an accumulative stress data set corresponding to a next display area of the display panel 110 in the working memory 160 based on a part of a next reference video frame. As described above, only the accumulative stress data set corresponding to one selected display area may be updated based on each reference video frame. The accumulative stress data sets stored in the working memory 160 may be stored and/or updated into the nonvolatile memory 170, for example, in a period of time (e.g., a set or predetermined period of time).

The indicator generator 180 may generate a block indicator when power-on of the display device 100 is performed. The block indicator may indicate the display area where the update of the accumulative stress data set will start. In accordance with the block indicator, the deterioration compensator 121 may extract a video data block corresponding to the k-th display area from the reference video frame. In accordance with the extracted video data block, the deterioration compensator 121 may update the accumulative stress data set corresponding to the k-th display area of the working memory 160. In this case, the reference video frame may be a video frame that is first provided after the power-on. Then, the deterioration compensator 121 may extract the video data block corresponding to the (k+1)-th display area from a next reference video frame. In accordance with the extracted video data block, the deterioration compensator 121 may update the accumulative stress data set corresponding to the (k+1)-th display area of the working memory 160.

It may be understood that the block indicator indicates one of the video data blocks included in the reference video frame. In this case, the video data blocks may correspond to the display areas of the display panel 110, respectively. The block indicator may have any one of values in a numerical range corresponding to the number of video data blocks (or display areas) included in the reference video frame.

The reference video frame may be a modified video frame MFR. However, the embodiments are not limited thereto. For example, the reference video frame may be the input video frame IFR. As another example, the reference video frame may be a video frame that is generated through additional processes for the input video frame IFR or the modified video frame MFR.

The deterioration compensator 121 may output the modified video frame MFR by performing compensation for the input video frame IFR in accordance with the accumulative stress data sets being updated.

The power management integrated circuit (PMIC) may provide power voltages to constituent elements of the display device 100. The power management integrated circuit (PMIC) may receive an input voltage from an external device such as a battery, and may generate the power voltages by using the received input voltage. The generated power voltages may be supplied to the constituent elements of the display device 100. The power management integrated circuit (PMIC) generates relatively high power voltages, and thus the voltage and current inside the power management integrated circuit (PMIC) may be relatively high. Accordingly, the power management integrated circuit (PMIC) may be provided as a constituent element separated from the timing controller 120.

According to some embodiments, the working memory 160 may include at least one of memories, such as RAM, dynamic RAM (DRAM), static RAM (SRAM), synchronous dynamic RAM (SDRAM), or double data rate synchronous dynamic random access memory (DDR SDRAM).

According to some embodiments, the nonvolatile memory 170 may include at least one of storage media, such as a flash memory, which maintain data even if the power is blocked.

According to some embodiments, the timing controller 120, the bus system 150, the working memory 160, the nonvolatile memory 170, and the indicator generator 180 may be included in a control board CB of FIG. 1. The timing controller 120 may be connected to other constituent elements of the display device 100, such as the scan driver 130, the data driver 140, and the display panel 110, through input/output interfaces (e.g., signal pads) of the control board CB. According to some embodiments, the control board CB may further include at least parts of the scan driver 130 and the data driver 140.

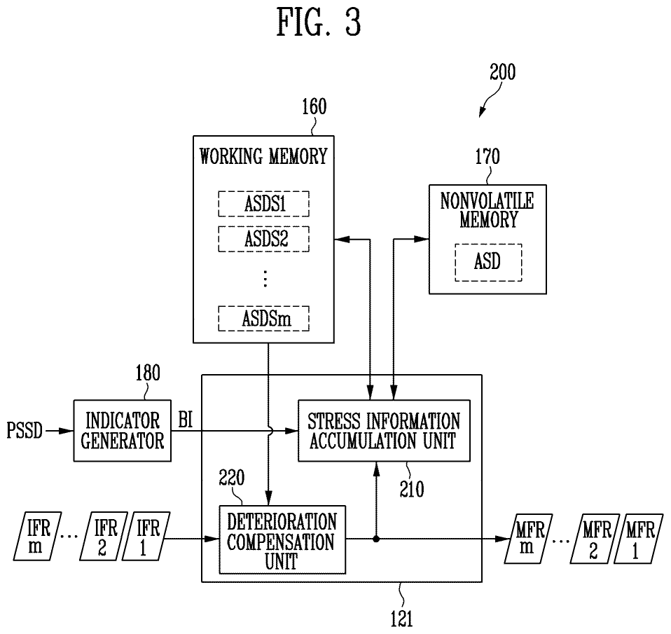

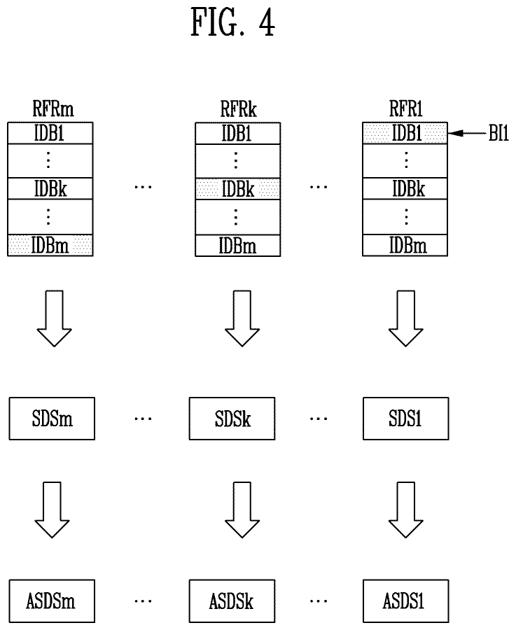

FIG. 3 is a block diagram showing aspects of a control board of FIG. 1. FIG. 4 is a diagram showing an example of processes of updating first to m-th accumulative stress data sets based on first to m-th reference video frames. FIG. 5 is a diagram conceptually showing the relationship between display areas of the display panel of FIG. 1 and video data blocks of a reference video frame.

Referring to FIG. 3, the indicator generator 180 may receive power state data PSSD. The power state data PSSD may be received from the power management integrated circuit PMIC and/or the timing controller 120 of FIG. 1. The power state data PSSD may include information indicating that the display device 100 (refer to FIG. 1) is in a power-on (or power-up) state. The indicator generator 180 may detect that the display device 100 is in the power-on (or power-up) state according to the power state data PSSD, and may output a block indicator BI in response to the detection.

The block indicator BI may indicate a display area where the update of the accumulative stress data set will first start after the power-on. According to some embodiments, the block indicator BI may have any one of values in a numerical range (e.g., a set or predetermined numerical range), and according to the value of the block indicator BI, the display area where the update of the accumulative stress data set will start may be determined.

The deterioration compensator 121 may include a stress information accumulation unit 210 and a deterioration compensation unit 220. The constituent elements of the deterioration compensator 121, such as the stress information accumulation unit 210 and the deterioration compensation unit 220, may read and write data from and in the working memory 160 and the nonvolatile memory 170 by accessing them.

The stress information accumulation unit 210 operates in response to the control of the deterioration compensation unit 220. The stress information accumulation unit 210 is configured to update first to m-th accumulative stress data sets ASDS1 to ASDSm in the working memory 160. The first to m-th accumulative stress data sets ASDS1 to ASDSm represent accumulative stresses of the first to m-th display areas of the display panel 110, respectively. The stress information accumulation unit 210 may start to update the accumulative stress data set corresponding to the block indicator BI after the power-on, and then may sequentially update next accumulative stress data sets.

The deterioration compensation unit 220 is configured to generate first to m-th modified video frames MFR1 to MFRm by compensating for (or modifying) first to m-th input video frames IFR1 to IFRm based on the first to m-th accumulative stress data sets ASDS1 to ASDSm. For example, the deterioration compensation unit 220 may generate the modified video frame by adding compensation values to gray scale values of the data pixels of the input video frame. Such compensation values may be determined based on the first to m-th accumulative stress data sets ASDS1 to ASDSm.

According to some embodiments, the control board 200 may further include a processor that performs various processes, such as changing of the data format and/or arrangement of each of the first to m-th modified video frames MFR1 to MFRm so as to fit the display panel 110.

Referring to FIGS. 3 and 4 together, the stress information accumulation unit 210 may update the first to m-th accumulative stress data sets ASDS1 to ASDSm based on first to m-th reference video frames RFR1 to RFRm. According to some embodiments, the first to m-th reference video frames RFR1 to RFRm may be the first to m-th modified video frames MFR1 to MFRm. In other embodiments, the first to m-th reference video frames RFR1 to RFRm may be the first to m-th input video frames IFR1 to IFRm. In still other embodiments, the first to m-th reference video frames RFR1 to RFRm may be video frames that are generated through additional processes for the first to m-th modified video frames MFR1 to MFRm.

Referring to FIG. 5, the display panel 110 may be separated into and/or defined by first to m-th display areas DR1 to DRm. Each of the first to m-th display areas DR1 to DRm may include a plurality of unit pixels UPX. The plurality of unit pixels UPX may include, for example, sub-pixels, such as at least one red sub-pixel, at least one green sub-pixel, and at least one blue sub-pixel. The sub-pixel may be provided as the pixel PX of FIG. 1. The plurality of unit pixels UPX may be grouped into pixel groups. For example, one pixel group PG may include four unit pixels UPX. However, the embodiments are not limited thereto. The pixel group PG may include more than four unit pixels UPX.

The p-th (where, p is an integer that is larger than or equal to 1 and smaller than or equal to m) reference video frame RFRp may be separated into first to m-th video data blocks IDB1 to IDBm. As shown as arrows of FIG. 5, the first to m-th video data blocks IDB1 to IDBm may be displayed in the first to m-th display areas DR1 to DRm, respectively.

Each of the first to m-th video data blocks IDB1 to IDBm may include a plurality of data pixels DPX. Each of the data pixels DPX may be displayed by the unit pixels UPX. The data pixels DPX may be grouped into data pixel groups. For example, in case that one pixel group PG includes four unit pixels UPX, one data pixel group DPG may include four data pixels DPX.

Only one (e.g., IDPp) of the first to m-th video data blocks IDB1 to IDBm may be extracted from the p-th reference video frame RFRp, and a stress data set for the corresponding display area (e.g., DRp) may be generated based on the extracted video data block. The remaining video data blocks of the p-th reference video frame RFRp may not be used to generate the stress data sets.

The generated stress data set may include a stress value corresponding to each data pixel group DPG. The stress value may be determined in accordance with an average value of gray scale values of the data pixels DPX included in the corresponding data pixel group DPG. For example, the stress value may include an average value of red gray scale values of four data pixels DPX, an average value of green gray scale values of the four data pixels DPX, and an average value of blue gray scale values of the four data pixels DPX. Accordingly, each stress data set may include stress values of a plurality of data pixel groups.

Referring again to FIGS. 3 and 4, it is illustrated that the first block indicator BI1 indicates the first video data block IDB1. In other words, the block indicator BI of FIG. 3 may be provided as the first block indicator BI1. In this case, as illustrated in FIG. 4, the first stress data set SDS1 is generated from the first reference video frame RFR1, the k-th (where, k is an integer that is larger than or equal to 1 and smaller than or equal to m) stress data set SDSk is generated from the k-th reference video frame RFRk, and the m-th stress data set SDSm is generated from the m-th reference video frame RFRm.

As described above with reference to FIG. 5, the first to m-th video data blocks IDB1 to IDBm of each reference video frame correspond to the first to m-th display areas DR1 to DRm, respectively. The first to m-th stress data sets SDS1 to SDSm may correspond to the first to m-th display areas DR1 to DRm, respectively. The first to m-th stress data sets SDS1 to SDSm may represent the stresses that are applied to the first to m-th display areas DR1 to DRm, respectively.

The stress information accumulation unit 210 may update the first to m-th accumulative stress data sets ASDS1 to ASDSm of the working memory in accordance with the first to m-th stress data sets SDS1 to SDSm.

The accumulative stress data set may include an accumulative stress value corresponding to each data pixel group DPG. According to some embodiments, the accumulative stress value may be updated to a value obtained by adding the stress value of the stress data set to the existing accumulative stress value. For example, each stress value is expressed as a set of 8 data bits corresponding to red, 8 data bits corresponding to green, and 8 data bits corresponding to blue. Each accumulative stress value is expressed as a set of 42 data bits corresponding to red, 42 data bits corresponding to green, and 42 data bits corresponding to blue. In this case, the accumulative stress value of 42 data bits will be updated to a new accumulative stress value through being added to the stress value of 8 data bits. Accordingly, each accumulative stress data set may include accumulative stress values of a plurality of data pixel groups.

The stress information accumulation unit 210 selects only one video data block from each reference video frame, and updates the accumulative stress data set for one display area in accordance with the selected video data block. The stress information accumulation unit 210 may update the first to m-th accumulative stress data sets ASDS1 to ASDSm corresponding to the first to m-th display areas DR1 to DRm, respectively, by extracting a different video data block from each of the first to m-th video frames RFR1 to RFRm. Accordingly, in relation to each reference video frame, only one accumulative stress data set may be updated to the working memory 160. This means that an input/output bandwidth that is required for the working memory 160 is decreased. Accordingly, relatively few resources may be required for the processes related to the first to m-th accumulative stress data sets ASDS1 to ASDSm.

According to some embodiments, the stress information accumulation unit 210 and the deterioration compensation unit 220 may be integrated with each other, or may be separated into more constituent elements. According to some embodiments, each of the stress information accumulation unit 210 and the deterioration compensation unit 220 may be implemented by hardware, software, firmware, and a combination thereof.

The stress information accumulation unit 210 may store (or back up) the first to m-th accumulative stress data sets ASDS1 to ASDSm of the working memory 160 in the nonvolatile memory 170 as accumulative stress data ASD. In case of the power-on, the accumulative stress data ASD of the nonvolatile memory 170 may be loaded on the working memory 160 as the first to m-th accumulative stress data sets ASDS1 to ASDSm. According to some embodiments, the first to m-th accumulative stress data sets ASDS1 to ASDSm may be stored from the working memory 160 to the nonvolatile memory 170 periodically and/or in case of power-off.

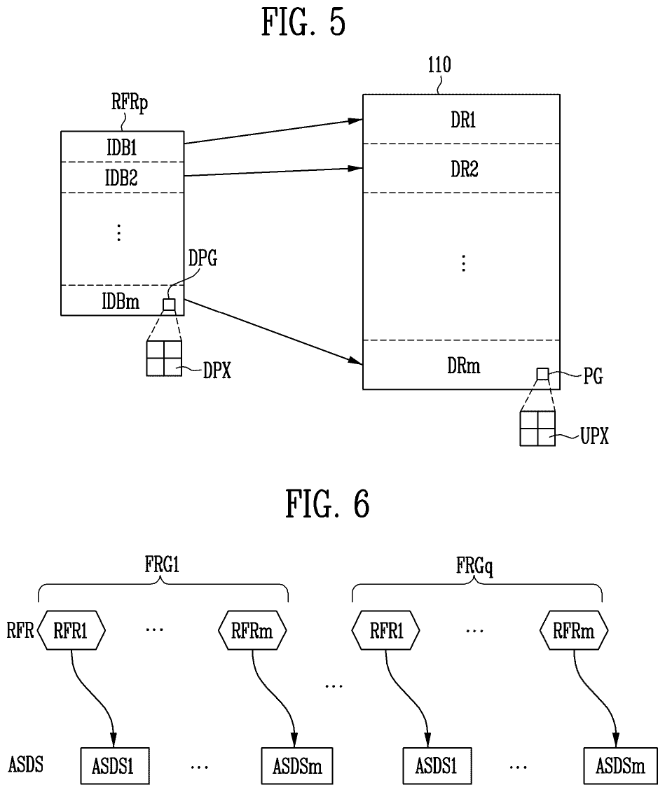

FIG. 6 is a diagram conceptually showing processes of updating first to q-th accumulative stress data sets based on first to q-th frame groups.

Referring to FIG. 6, each of first to q-th frame groups FRG1 to FRGq may include the first to m-th reference video frames RFR1 to RFRm as described above with reference to FIG. 4.

According to some embodiments, the stress information accumulation unit 210 may update the first to m-th accumulative stress data sets ASDS1 to ASDSm based on the corresponding first to m-th reference video frames RFR1 to RFRm whenever each of the first to q-th frame groups FRG1 to FRGq is received. In other embodiments, when some of the first to q-th frame groups FRG1 to FRGq are received, the stress information accumulation unit 210 may update the first to m-th accumulative stress data sets ASDS1 to ASDSm based on the corresponding first to m-th reference video frames RFR1 to RFRm. For example, when each of the first to q-th frame groups FRG1 to FRGq is received, the stress information accumulation unit 210 may update the first to m-th accumulative stress data sets ASDS1 to ASDSm based on the corresponding first to m-th reference video frames RFR1 to RFRm.

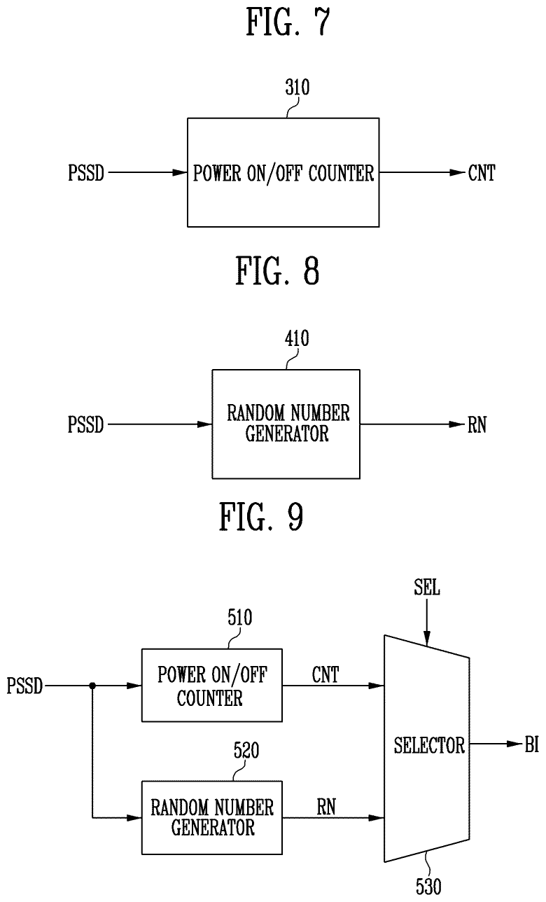

FIG. 7 is a block diagram showing aspects of an indicator generator of FIG. 3 according to some embodiments.

Referring to FIG. 7, the indicator generator 180 of FIG. 3 may include a power on/off counter 310 configured to generate a count value CNT in response to the power state data PSSD. The count value CNT may be provided as the block indicator BI of FIG. 3.

The power on/off counter 310 may detect the power-on of the display device 100 in accordance with the power state data PSSD. The count value CNT may be any one of values in a numerical range corresponding to the first to m-th display areas DR1 to DRm, and may be sequentially changed in a circular manner whenever the power-on of the display device 100 is performed. For example, the count value CNT may sequentially increase from 1 to m whenever the power-on is performed, and after the count value CNT of m is output, the count value CNT may be 1 when the next power-on is performed.

The count value CNT represents the video data block where the update of the accumulative stress data set will start. It is assumed that the count value CNT indicates the k-th video data block. Referring to FIGS. 4 and 7 together, in case of the power-on, the k-th accumulative stress data set ASDSk may be updated based on the first reference video frame RFR1 that is first provided. Thereafter, based on the next reference video frames RFRk+1 to RFRm sequentially, the corresponding accumulative stress data sets may be updated. In other words, starting with the accumulative stress data set corresponding to the count value CNT, the first to m-th accumulative stress data sets ASDS1 to ASDSm may be sequentially updated in a circular manner.

In case of the next power-on after the power-off, the count value CNT will indicate the (k+1)-th video data block. Based on the first reference video frame RFR1 that is first provided, the (k+1)-th accumulative stress data set ASDSk+1 may be updated. Thereafter, based on the next reference video frames RFRk+2 to RFRm sequentially, the corresponding accumulative stress data sets may be updated. Starting with the accumulative stress data set corresponding to the count value CNT, the first to m-th accumulative stress data sets ASDS1 to ASDSm may be sequentially updated in a circular manner.

As described above, whenever the power-on of the display device 100 is performed, the first to m-th accumulative stress data sets ASDS1 to ASDSm may be updated, starting with the different accumulative stress data set.

FIG. 8 is a block diagram showing aspects of an indicator generator of FIG. 3 according to some embodiments.

Referring to FIG. 8, the indicator generator 180 of FIG. 3 may include a random number generator 410 configured to generate a random number RN in response to the power state data PSSD. The random number RN may be provided as the block indicator BI of FIG. 3.

The random number generator 410 may detect the power-on of the display device 100 in accordance with the power state data PSSD. The random number RN may be any one of values in a numerical range corresponding to the first to m-th display areas DR1 to DRm.

The random number RN represents the video data block where the update of the accumulative stress data set will start. It is assumed that the random number RN indicates the k-th video data block. Referring to FIGS. 4 and 8 together, in case of the power-on, the k-th accumulative stress data set ASDSk may be updated based on the first reference video frame RFR1 that is first provided. Thereafter, based on the next reference video frames RFRk+1 to RFRm sequentially, the corresponding accumulative stress data sets may be updated. Starting with the accumulative stress data set corresponding to the random number RN, the first to m-th accumulative stress data sets ASDS1 to ASDSm may be sequentially updated in a circular manner.

FIG. 9 is a block diagram showing further details of an indicator generator of FIG. 3 according to some embodiments.

Referring to FIG. 9, the indicator generator 180 of FIG. 3 may include a power on/off counter 510, a random number generator 520, and a selector 530. The power on/off counter 510 is configured in the same manner as the power on/off counter 310 as described above with reference to FIG. 7. The random number generator 520 is configured in the same manner as the random number generator 410 as described above with reference to FIG. 8. Hereinafter, the duplicate description thereof will be omitted.

The selector 530 receives the count value CNT from the power on/off counter 510, and receives the random number RN from the random number generator 520. The selector 530 receives a selection signal SEL. According to some embodiments, the selection signal SEL may be provided from the timing controller 120 of FIG. 1.

The selector 530 is configured to output any one of the count value CNT or the random number RN as the block indicator BI in response to the selection signal SEL. For example, the selector 530 may output the count value CNT as the block indicator BI when the selection signal SEL is enabled. The selector 530 may output the random number RN as the block indicator BI when the selection signal SEL is disabled.

The timing controller 120 may include a storage medium that stores therein a register value corresponding to the selection signal SEL. In accordance with the register value, the timing controller 120 may generate the selection signal SEL. Accordingly, in consideration of the characteristics of the input video frame IFR and/or the display device 100, any one of the count value CNT or the random number RN may be selected as the block indicator BI. As described above, the block indicator BI that fits the input video frame IFR and/or the display device 100 may be provided.

In case of a sudden power-off, only the update of some of the first to m-th accumulative stress data sets ASDS1 to ASDSm (refer to FIG. 3) may be reflected in the accumulative stress data ASD (refer to FIG. 3), and the update of the rest thereof may not be reflected in the accumulative stress data ASD. For example, in a state where the first to (i−1)-th (where, i is an integer that is larger than or equal to 1 and smaller than or equal to m) accumulative stress data sets have been updated, the first to m-th accumulative stress data sets ASDS1 to ASDSm may be updated into the accumulative stress data ASD. Then, after the update of the i-th to m-th accumulative stress data sets ASDSi to ASDSm, the power may be suddenly turned off. In this case, only the updated first to (i−1)-th accumulative stress data sets ASDS1 to ASDSi−1 are reflected in the accumulative stress data ASD, but the updated i-th to m-th accumulative stress data sets ASDSi to ASDSm may not be reflected in the accumulative stress data ASD. If the sudden power-off is repeated in a state where the update starts from the fixed accumulative stress data set (e.g., ASDS1) whenever the power-on is performed, the update of a specific accumulative stress data set (e.g., ASDS1) may be reflected in the accumulative stress data ASD relatively much. In contrast, the update of the other accumulative stress data set (e.g., ASDSm) may be reflected in the accumulative stress data ASD relatively little.

According to some embodiments of the present disclosure, the block indicator BI that is changed whenever the power-on of the display device 100 is performed is provided. Starting with the update of the accumulative stress data set corresponding to the block indicator BI, the first to m-th accumulative stress data sets ASDS1 to ASDSm are updated in a circular manner. Accordingly, it may be expected that the accumulative stress data sets for which the update is unable to be reflected in the accumulative stress data ASD become different whenever the sudden power-off occurs. As described above, even if the sudden power-off is repeated, the update of the first to m-th accumulative stress data sets ASDS1 to ASDSm may be reflected in the accumulative stress data ASD relatively uniformly. Accordingly, the first to m-th accumulative stress data sets ASDS1 to ASDSm and the accumulative stress data ASD may have relatively high reliability. Accordingly, the display device 100 may perform compensation for the input video frame with the relatively high reliability based on the first to m-th accumulative stress data sets ASDS1 to ASDSm, and may display the video with relatively improved reliability.

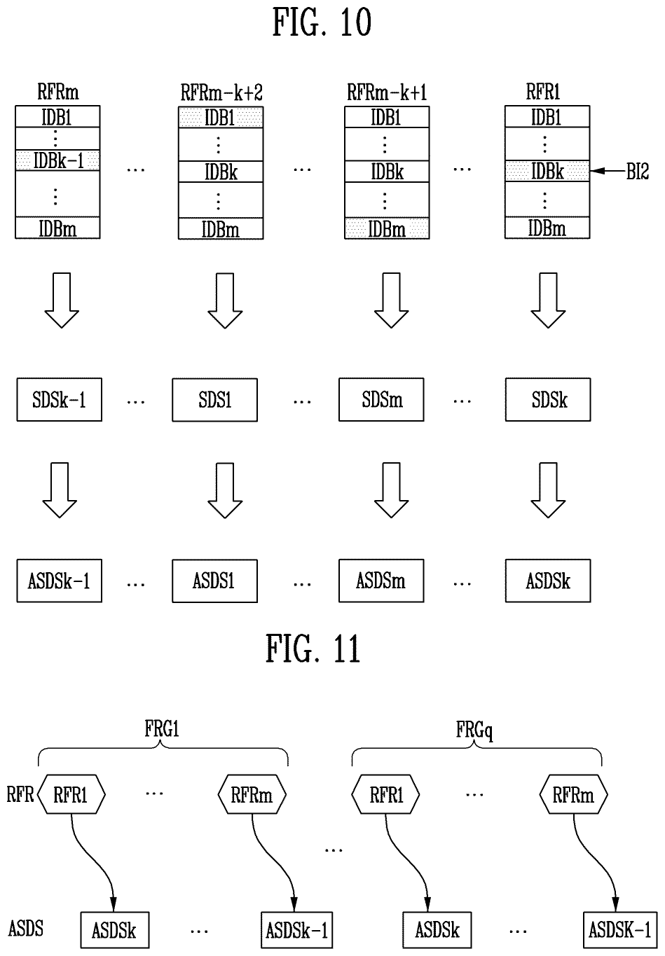

FIG. 10 is a diagram showing another example of processes of updating first to m-th accumulative stress data sets based on first to m-th reference video frames.

Referring to FIGS. 3 and 10, the stress information accumulation unit 210 may update the first to m-th accumulative stress data sets ASDS1 to ASDSm based on the first to m-th reference video frames RFR1 to RFRm.

In FIG. 10, it is shown that the second block indicator BI2 indicates the k-th video data block IDBk. Here, the block indicator BI of FIG. 3 may be provided as the second block indicator BI2. In this case, based on the first to m-th reference video frames RFR1 to RFRm, the k-th to m-th accumulative stress data sets ASDSk to ASDSm and the first to (k−1)-th accumulative stress data sets ASDS1 to ASDSk−1 may be updated sequentially.

As illustrated in FIG. 10, the k-th stress data set SDSk is generated from the first reference video frame RFR1. The m-th stress data set SDSm is generated from the (m−k+1)-th reference video frame RFRm−k+1. The first stress data set SDS1 is generated from the (m−k+2)-th reference video frame RFRm−k+2. Further, the (k−1)-th stress data set SDSk−1 is generated from the m-th reference video frame RFRm.

In accordance with the k-th to m-th stress data sets SDSk to SDSm and the first to (k−1)-th stress data sets SDS1 to SDSk−1, the stress information accumulation unit 210 may update the k-th to m-th accumulative stress data sets ASDSk to ASDSm and the first to (k−1)-th accumulative stress data sets ASDS1 to ASDSk−1, respectively.

As described above, starting with the k-th accumulative stress data set ASDSk corresponding to the second block indicator BI2, the first to m-th stress data sets ASDS1 to ASDSm may be sequentially updated in a circular manner.

FIG. 11 is a diagram showing another example of processes of updating first to m-th accumulative stress data sets based on first to z-th frame groups.

Referring to FIGS. 10 and 11, the first to q-th frame groups FRG1 to FRGq may be received sequentially. Each of the first to q-th frame groups FRG1 to FRGq may include the first to m-th reference video frames RFR1 to RFRm.

According to some embodiments, based on the first to m-th reference video frames RFR1 to RFRm of each frame group, the k-th to m-th accumulative stress data sets ASDSk to ASDSm and the first to (k−1)-th accumulative stress data sets ASDS1 to ASDSk−1 may be updated. In other embodiments, when some of the first to q-th frame groups FRG1 to FRGq are received, the k-th to m-th accumulative stress data sets ASDSk to ASDSm and the first to (k−1)-th accumulative stress data sets ASDS1 to ASDSk−1 may be updated based on the corresponding first to m-th reference video frames RFR1 to RFRm. For example, when the first frame group FRG1 and the q-th frame group FRGq are received, the k-th to m-th accumulative stress data sets ASDSk to ASDSm and the first to (k−1)-th accumulative stress data sets ASDS1 to ASDSk−1 may be updated based on the corresponding first to m-th reference video frames RFR1 to RFRm.

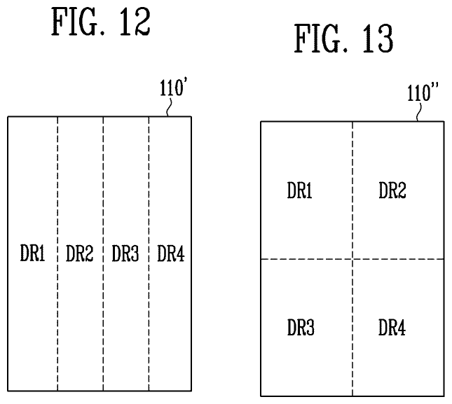

FIGS. 12 and 13 are block diagrams showing embodiments of display areas that may be separated in various ways.

Referring to FIG. 12, a display panel 110′ may include a plurality of display areas DR1 to DR4 that are arranged in a row direction. Referring to FIG. 13, a display panel 110″ may include a plurality of display areas DR1 to DR4 that are arranged in row and column directions. In other embodiments, the display panel 110 may include a plurality of display rears DR1 to DRm that are arranged in a column direction as illustrated in FIG. 5.

As described above, the display panel 110 of FIG. 1 may be separated into (or defined by) display areas having various shapes. In this case, the reference video frame may be separated into video data blocks corresponding to the corresponding display areas. The separated video data blocks may be displayed by the display areas, respectively.

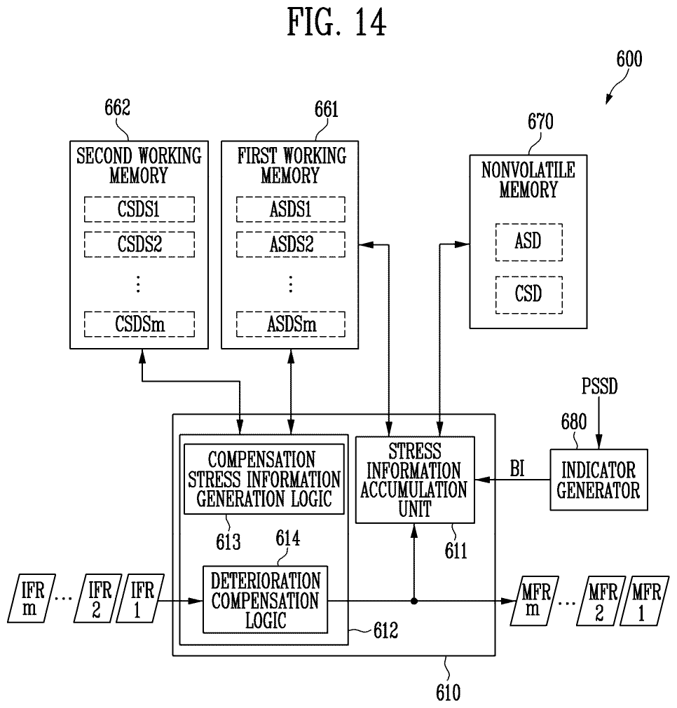

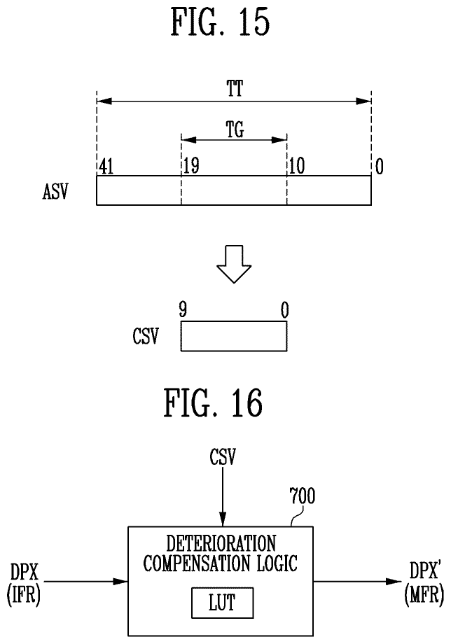

FIG. 14 is a block diagram showing further details of a control board of FIG. 1 according to some embodiments. FIG. 15 is a diagram conceptually showing an accumulative stress value and a compensatory stress value.

Referring to FIG. 14, a control board 600 may include a deterioration compensator 610, a first working memory 661, a second working memory 662, and a nonvolatile memory 670. The first and second working memories 661 and 662 may be provided as the working memory 160 of FIG. 1. The nonvolatile memory 670 may be provided as the nonvolatile memory 170 of FIG. 1.

The deterioration compensator 610 may be provided as the deterioration compensator 121 of FIG. 1. The deterioration compensator 610 may include a stress information accumulation unit 611 and a deterioration compensation unit 612. The stress information accumulation unit 611 will be described in the same manner as the stress information accumulation unit 210 as described above with reference to FIG. 3. The stress information accumulation unit 611 operates in response to the control of a deterioration compensation logic 614 of the deterioration compensation unit 612. Hereinafter, the duplicate description thereof will be omitted.

The deterioration compensation unit 612 is configured to generate first to m-th modified video frames MFR1 to MFRm by modifying first to m-th input video frames IFR1 to IFRm based on the first to m-th accumulative stress data sets ASDS1 to ASDSm. For this, the deterioration compensation unit 612 may include a compensation stress information generation logic 613 and a deterioration compensation logic 614.

The compensation stress information generation logic 613 operates in response to the control of the deterioration compensation logic 614. The compensation stress information generation logic 613 may access first and second working memories 661 and 662. The compensation stress information generation logic 613 may update first to m-th compensation stress data sets CSDS1 to CSDSm, for example, periodically, based on the first to m-th accumulative stress data sets ASDS1 to ASDSm. The accumulative stress values of each accumulative stress data set may be changed to compensation stress values of the corresponding compensation stress data set. Referring to FIG. 15, the accumulative stress value ASV of the accumulative stress data set may include a number of data bits (e.g., a set or predetermined number of data bits) TT. For example, the accumulative stress value ASV may include total 42 data bits of [41:0].

Specific data bits between the most significant data bits and the least significant data bits among the whole data bits TT of the accumulative stress value ASV may be defined as target data bits TG. In accordance with the target data bits TG, the compensation stress value CSV may be determined. For example, 10 data bits of [19:10] may be extracted among the whole data bits TT of the accumulative stress value ASV, and the extracted 10 data bits may be determined as the compensation stress value CSV. According to embodiments, at least one of various methods and/or algorithms may be adopted, and the compensation stress value CSV may be determined from the target data bits TG.

Referring again to FIG. 14, the stress information accumulation unit 611 may store (or back up) the first to m-th compensation stress data sets CSDS1 to CSDSm in the nonvolatile memory 670 as compensation stress data CSD. According to some embodiments, the first to m-th compensation stress data sets CSDS1 to CSDSm may be stored periodically and/or in case of the power-off as the compensation stress data CSD. In case of the power-on, the first to m-th compensation stress data sets CSDS1 to CSDSm may be loaded from the nonvolatile memory 670 to the second working memory 662.

The operations for the compensation stress information generation logic 613 to update the first to m-th compensation stress data sets CSDS1 to CSDSm may not overlap in time the operations for the stress information accumulation unit 611 to update the first to m-th accumulative stress data sets ASDS1 to ASDSm. This enables the input/output bandwidth, which is required for communication channels between the first and second working memories 661 and 662 and the deterioration compensator 610, not to increase. Such a control may be performed by the deterioration compensation logic 614. For this, the first to m-th accumulative stress data sets ASDS1 to ASDSm may be stored in the first working memory 661, and the first to m- the compensation stress data sets CSDS1 to CSDSm may be stored in the second working memory 662. The first and second working memories 661 and 662 may be physically separated. Further, the first and second working memories 661 and 662 may be integrated into one memory, and in this case, the first and second working memories 661 and 662 may be logically separated.

The deterioration compensation logic 614 is configured to generate the first to m-th modified video frames MFR1 to MFRm by modifying the first to m-th input video frames IFR1 to IFRm based on the first to m-th compensation stress data sets CSDS1 to CSDSm.

According to some embodiments, at least some of the stress information accumulation unit 611, the compensation stress information generation logic 613, and the deterioration compensation logic 614 may be integrated with each other, or may be separated into more constituent elements. According to some embodiments, each of the stress information accumulation unit 611, the compensation stress information generation logic 613, and the deterioration compensation logic 614 may be implemented by hardware, software, firmware, and a combination thereof.

FIG. 16 is a block diagram showing aspects of a deterioration compensation logic of FIG. 14 according to some embodiments.

Referring to FIG. 16, a deterioration compensation logic 700 may output a data pixel DPX′ of a modified video frame MFR by compensating for a data pixel DPX included in the input video frame IFR. The input video frame IFR may be any one of the first to m-th input video frames IFR1 to IFRm. The modified video frame MFR may be any one of the first to m-th modified video frames MFR1 to MFRm of FIG. 14.

The deterioration compensation logic 700 may include at least one lookup table LUT. The deterioration compensation logic 700 obtains a compensation stress value CSV (refer to FIG. 15) corresponding to the data pixel DPX or the data pixel group DPG (refer to FIG. 5) to which the data pixel belongs from the second working memory 662. The deterioration compensation logic 700 obtains a compensation value corresponding to the compensation stress value CSV from the lookup table LUT. The deterioration compensation logic 700 may determine the data pixel DPX′ of the modified video frame MFR by reflecting the obtained compensation value in the gray scale value of the data pixel DPX. For example, the data pixel DPX′ of the modified video frame MFR may be determined by adding the compensation value to the gray scale value of the data pixel DPX of the input video frame IFR.

As described above, the deterioration compensation logic 700 may generate the modified video frame MFR from the input video frame IFR by using the first to m-th compensation stress data sets CSDS1 to CSDSm of FIG. 14.

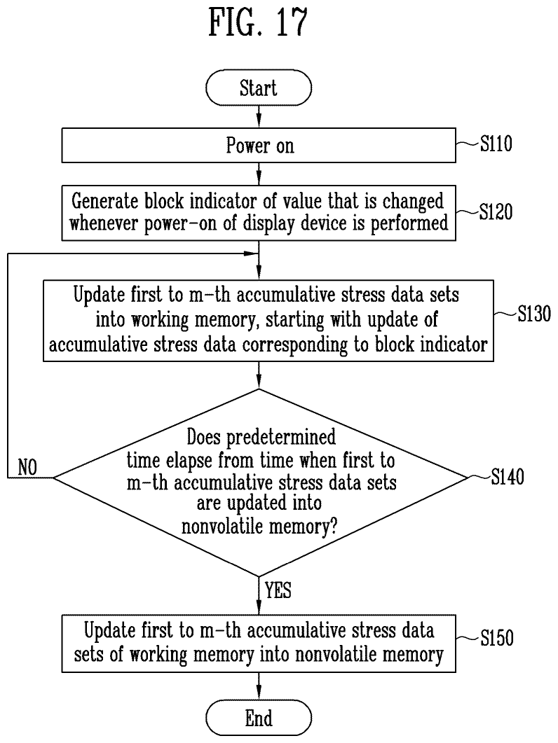

FIG. 17 is a flowchart showing aspects of a method for storing first to m-th accumulative stress data sets in a nonvolatile memory. Although FIG. 17 illustrates various operations in a method for storing stress data sets, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIGS. 3 and 17, in operation S110, the power of the display device 100 (refer to FIG. 1) is turned on.

In operation S120, the block indicator BI of the value that is changed whenever the power-on of the display device 100 is performed.

In operation S130, the first to m-th accumulative stress data sets ASDS1 to ASDSm are updated to the working memory 160. The first to m-th modified video frames MFR1 to MFRm may be used as the reference video frames. Starting with the update of the accumulative stress data corresponding to the block indicator BI, the first to m-th accumulative stress data sets ASDS1 to ASDSm may be updated.

In operation S140, it is determined if a time (e.g., a set or predetermined time) elapses from the time when the first to m-th accumulative stress data sets ASDS1 to ASDSm are updated to the nonvolatile memory 170 as the accumulative stress data ASD. If not, the operation S130 is performed again. As described above, the first to m-th accumulative stress data sets ASDS1 to ASDSm may be repeatedly updated based on the first to m-th modified video frames MFR1 to MFRm of the next frame group.

In operation S150, the first to m-th accumulative stress data sets ASDS1 to ASDSm of the working memory 160 are updated to the nonvolatile memory 170 as the accumulative stress data ASD. As described above, the first to m-th accumulative stress data sets ASDS1 to ASDSm may be updated to the nonvolatile memory 170 in a period of time (e.g., a set or predetermined period of time).

The power may be suddenly turned off while the operation S130 is performed. In case of such a sudden power-off, the update of some of the first to m-th accumulative stress data sets ASDS1 to ASDSm may not be reflected in the accumulative stress data ASD. In other words, the update of some of the first to m-th accumulative stress data sets ASDS1 to ASDSm may be volatilized.

According to some embodiments of the present disclosure, the block indicator BI that is changed whenever the power-on of the display device 100 is performed is provided. Starting with the update of the accumulative stress data set corresponding to the block indicator BI, the first to m-th accumulative stress data sets ASDS1 to ASDSm are updated in a circular manner. Accordingly, it may be expected that the accumulative stress data sets for which the update is unable to be reflected in the accumulative stress data ASD become different whenever the sudden power-off occurs. As described above, even if the sudden power-off is repeated, the update of the first to m-th accumulative stress data sets ASDS1 to ASDSm may be reflected in the accumulative stress data ASD relatively uniformly. Accordingly, the first to m-th accumulative stress data sets ASDS1 to ASDSm and the accumulative stress data ASD may have relatively high reliability. Accordingly, the compensation for the input video frame may be performed with the relatively high reliability based on the first to m-th accumulative stress data sets ASDS1 to ASDSm, and thus the video may be displayed with relatively improved reliability.

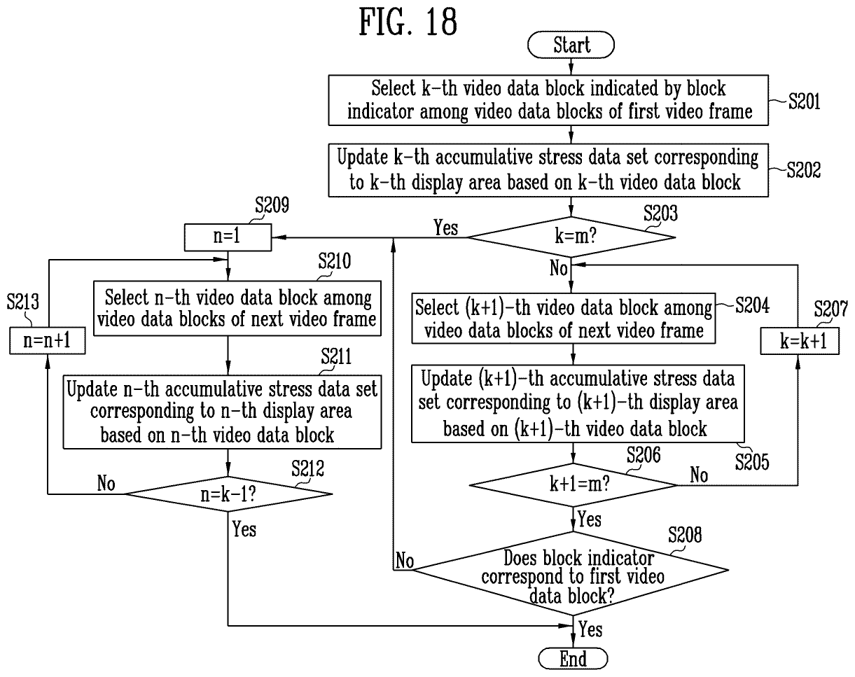

FIG. 18 is a flowchart showing further details of the operation S130 of FIG. 17. Although FIG. 18 illustrates various operations in the operation S130, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIGS. 3 and 18, in operation S201, among the video data blocks IDB1 to IDBm (refer to FIG. 5) of the first modified video frame MFR1, the k-th (where, k is an integer that is larger than or equal to 1 and smaller than or equal to m) video data block IDBk that is indicated by the block indicator BI is selected. As described above, the video data block IDBk that is first selected after the power-on is determined by the block indicator BI.

The block indicator BI indicates one of the video data blocks IDB1 to IDBm included in the video frame. Whenever the power-on of the display device 100 is performed, the video data block that is indicated by the block indicator BI may be changed.

In operation S202, the k-th accumulative stress data set ASDSk corresponding to the k-th display area DRk (refer to FIG. 5) is updated.

In operation S203, when k is different from m, operation S204 is performed. When k is equal to m, operation S209 is performed.

In operation S204, the (k+1)-th video data block IDBk+1 is selected among the video data blocks IDB1 to IDBm of the next video frame. In operation S205, the (k+1)-th accumulative stress data set ASDSk+1 corresponding to the (k+1)-th display area DRk+1 is updated based on the (k+1)-th video data block.

In operation S206, when k+1 is different from m, operation S207 is performed. When k+1 is equal to m, operation S208 is performed.

In the operation S207, k increases by 1. Then, the operation S204 is performed again. As described above, until k+1 reaches m, the operations S204 to S207 may be repeatedly performed.

In operation S208, when the block indicator BI does not correspond to the first video data block IDB1, operation S209 is performed.

If the block indicator BI indicates the first video data block IDB1, the first to m-th accumulative stress data sets ASDS1 to ASDSm may be updated through repeated performing of the operations S204 to S207. As described above with reference to FIG. 17, the operation S130 of FIG. 17 may be repeatedly performed.

In operation S209, n is set to 1. In operation S210, the n-th video data block IDBn is selected among the video data blocks IDB1 to IDBm of the next video frame. In operation S211, the n-th accumulative stress data set ASDSn corresponding to the n-th display area DRn is updated based on the n-th video data block IDBn. In operation S212, when n is different from k−1, operation S213 is performed.

In the operation S213, n increases by 1. Then, the operation S210 is performed again. As described above, the first to (k−1)-th accumulative stress data sets may be updated through repeated performing of the operations S210 to S213.

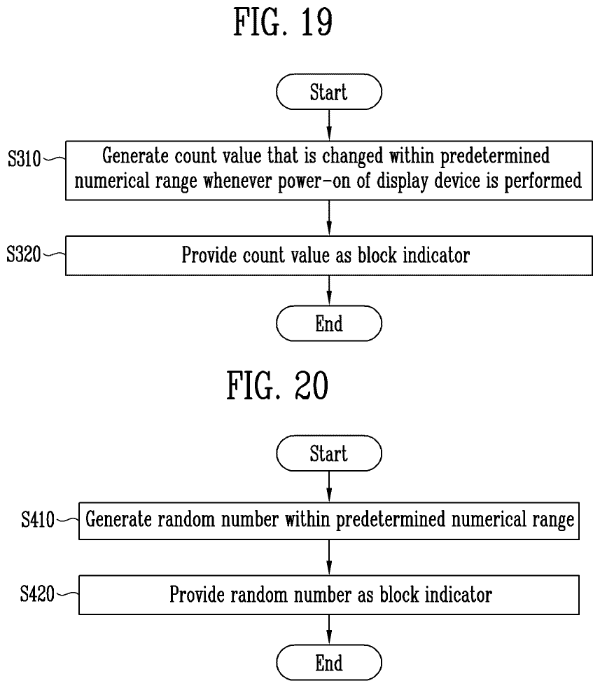

FIG. 19 is a flowchart showing further details of the operation S120 of FIG. 17. Although FIG. 19 illustrates various operations in the operation S120, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIGS. 3 and 19, in operation S310, a count value that is changed within a numerical range (e.g., a set or predetermined numerical range) is generated whenever the power-on of the display device 100 is performed. Values within the numerical range (e.g., the set or predetermined numerical range) may correspond to the first to m-th video data blocks IDB1 to IDBm (refer to FIG. 4). The count value may be any one of the values within the numerical range (e.g., the set or predetermined numerical range), and may be sequentially changed in a circular manner whenever the power-on of the display device 100 is performed.

In operation S320, the count value is provided as the block indicator BI.

FIG. 20 is a flowchart showing further details of the operation S120 of FIG. 17. Although FIG. 20 illustrates various operations in the operation S120, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIGS. 3 and 20, in operation S410, a random number is generated within a numerical range (e.g., a set or predetermined numerical range). Values within the numerical range (e.g., the set or predetermined numerical range) may correspond to the first to m-th video data blocks IDB1 to IDBm (refer to FIG. 4). The random number may be any one of the values within the numerical range (e.g., the set or predetermined numerical range), and may be randomly generated whenever the power-on of the display device 100 is performed.

In operation S420, the random number is provided as the block indicator BI.

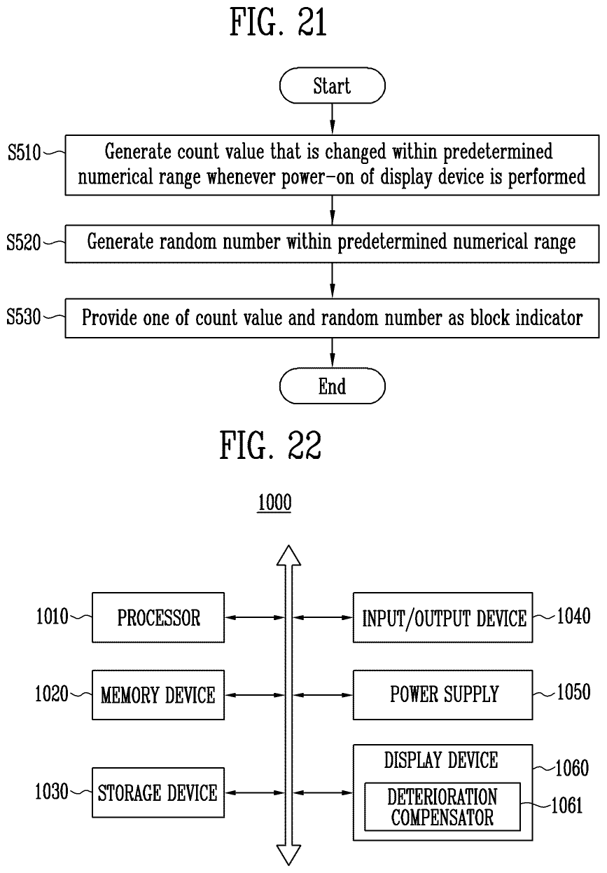

FIG. 21 is a flowchart showing further details of the operation S120 of FIG. 17. Although FIG. 21 illustrates various operations in the operation S120, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIGS. 3 and 21, in operation S510, a count value that is changed within a numerical range (e.g., a set or predetermined numerical range) is generated whenever the power-on of the display device 100 is performed. In operation S520, a random number is generated within the numerical range (e.g., the set or predetermined numerical range).

In operation S530, one of the count value and the random number is selected and provided as the block indicator BI.

Accordingly, any one of the count value or the random number may be selected as the block indicator BI in consideration of the characteristics of the input video frame IFR and/or the display device 100. Accordingly, the block indicator BI that fits the input video frame IFR and/or the display device 100 may be provided.

FIG. 22 is a block diagram showing a display system according to some embodiments of the present disclosure.

Referring to FIG. 22, a display system 1000 may include a processor 1010, a memory device 1020, a storage device 1030, an input/output (I/O) device 1040, a power supply 1050, and a display device 1060. The display system 1000 may further include ports for communicating with other devices, such as a video card, a sound card, a memory card, and a USB device.

The processor 1010 may perform various tasks and calculations. According to some embodiments, the processor 1010 may include an application processor, a graphic processing unit, a microprocessor, and a central processing unit (CPU). The processor 1010 may be connected to other constituent elements of the display system 1000 through a bus system. According to some embodiments, the bus system may include a peripheral component interconnect (PCI) bus. The processor 1010 may provide a data stream to be displayed on the display device 1060 to the display device 1060. The data stream may be provided to the display device 1060 as the input video frame IFR of FIG. 1. The processor 1010 may further transmit the control signals CTRL of FIG. 1 to the display device 1060.

The memory device 1020 may be provided as a working memory and/or buffer memory of the display system 1000 and/or the processor 1010. According to some embodiments, the memory device 1020 may include volatile memory devices, such as dynamic random access memory (DRAM), static random access memory (SRAM), and mobile DRAM.

The storage device 1030 may store therein data in response to the control of the processor 1010. The storage device 1030 may include a nonvolatile storage medium that maintains the data even if the power of the display system 1000 is blocked. According to some embodiments, the storage device 1030 may include a solid state drive (SSD), a hard disk drive (HDD), and the like.

According to some embodiments, at least a part of the memory device 1020 may be provided to the working memory 160 of FIG. 1. At least a part of the storage device 1030 may be provided as the nonvolatile memory 170 of FIG. 1. In this case, parts of the memory device 1020 and the storage device 1030 may be mounted on the control board CB of FIG. 1.

The input/output (I/O) device 1040 may include user input devices, such as a keyboard, a keypad, a touchpad, a touchscreen, and a mouse, and output devices, such as a speaker and a printer. The power supply 1050 may supply a power required for the operation of the display system 1000. For example, the power supply 1050 may include a battery.

The display device 1060 may display a video in response to the control of the processor 1010. The display device 100 of FIG. 1 may be provided as the display device 1060. The display device 1060 may include a deterioration compensator 1061, and the deterioration compensator 1061 may operate in the same manner as the deterioration compensator 121 of FIG. 1.

According to some embodiments, the display system 1000 may be a computer device or an electronic device including the display device 1060, such as a digital television (TV), a 3D TV, a personal computer (PC), a home appliance, a laptop computer, a table computer, a mobile phone, a smartphone, a personal digital assistant (PDA), a portable multimedia player (PMP), a digital camera, a music player, a portable game console, and a navigation device.

Although specific embodiments and application examples have been described herein, other embodiments and modifications can be derived from the above description. Accordingly, the scope of embodiments according to the present disclosure are not limited to the disclosed embodiments, but is intended to cover the appended claims, various modifications, and equivalents thereof.

What is claimed is:

1. A display device comprising:
a display panel including display areas;
a controller configured to control display a video through the display panel based on video frames being sequentially provided, each of the video frames including video data blocks corresponding to the display areas, respectively; and
an indicator generator configured to generate a block indicator having a value that is changed based on power-on being performed,
wherein the controller is configured to: select the video data block that is indicated by the block indicator from the video data blocks of a video frame that is first provided among the video frames, and update an accumulative stress data set of a corresponding display area from among the display areas based on the selected video data block of the video frame.

2. The display device of claim 1, wherein the block indicator indicates any one of the video data blocks.

3. The display device of claim 1, wherein the indicator generator comprises a counter to generate a count value that is changed based on the power-on being performed within a predetermined numerical range, and
wherein the count value is provided as the block indicator.

4. The display device of claim 1, wherein the indicator generator comprises a random number generator configured to generate a random number within a predetermined numerical range based on the power-on being performed, and
wherein the random number is provided as the block indicator.

5. The display device of claim 1, wherein the indicator generator comprises:
a counter configured to generate a count value that is changed based on the power-on being performed within a predetermined numerical range;
a random number generator configured to generate a random number within the predetermined numerical range based on the power-on being performed; and
a selector configured to provide any one of the count value or the random number to the block indicator.

6. The display device of claim 1, wherein the display areas comprises first to m-th (where, m is an integer that is larger than 1) display areas,
wherein the video frames include first to m-th video frames that are sequentially provided after the power-on,
wherein the video data blocks included in each of the first to m-th video frames include first to m-th video data blocks corresponding to the first to m-th display areas, respectively, and
wherein the video frame that is first provided among the video frames is the first video frame.

7. The display device of claim 6, wherein the block indicator indicates the k-th (where, k is an integer that is larger than or equal to 1 and smaller than or equal to m) video data block among the first to m-th video data blocks.

8. The display device of claim 7, wherein based on the block indicator indicating any one of the second to (m−1)-th video data blocks,
the controller is configured to:
select the k-th to m-th video data blocks and the first to (k−1)-th video data blocks from the first to m-th video frames, and
update k-th to m-th accumulative stress data sets and first to (k−1)-th accumulative stress data sets corresponding to the k-th to m-th display areas and the first to (k−1)-th display areas based on the k-th to m-th video data blocks and the first to (k−1)-th video data blocks, respectively.

9. The display device of claim 7, wherein based on the block indicator indicating the m-th video data block,
the controller is configured to:
select the m-th video data block and the first to (m−1)-th video data blocks from the first to m-th video frames, and
update an m-th accumulative stress data set and first to (m−1)-th accumulative stress data sets corresponding to the m-th display area and the first to (m−1)-th display areas based on the m-th video data block and the first to (m−1)-th video data blocks, respectively.

10. The display device of claim 7, wherein based on the block indicator indicating the first video data block,
the controller is configured to:
select the first to m-th video data blocks from the first to m-th video frames, and
update first to m-th accumulative stress data sets corresponding to the first to m-th display areas based on the first to m-th video data blocks, respectively.

11. The display device of claim 1, wherein the controller is configured to: extract a different video data block among the video data blocks from the respective video frames, and update the accumulative stress data set corresponding to the corresponding display area based on the different video data block.

12. The display device of claim 1, wherein the video frames are video frames that are first provided after the power-on.

13. The display device of claim 1, further comprising:
a working memory connected to the controller; and
a nonvolatile memory connected to the controller,
wherein the controller is configured to:
update the accumulative stress data set in the working memory, and
store the accumulative stress data set of the working memory in the nonvolatile memory in a predetermined period of time.

14. An operating method of a display device including display areas, the operating method comprising:
generating a block indicator having a value that is changed based on power-on being performed;
receiving video frames being sequentially provided and to be displayed on the display device as a video, each of the video frames including video data blocks corresponding to the display areas, respectively;
selecting a video data block that is indicated by the block indicator from the video data blocks of the video frame that is first provided among the video frames; and
updating an accumulative stress data set of a corresponding display area from among the display areas based on the selected video data block of the video frame.

15. The operating method of claim 14, wherein generating the block indicator comprises:
generating a count value that is changed based on the power-on being performed within a predetermined numerical range; and
providing the count value as the block indicator.

16. The operating method of claim 14, wherein generating the block indicator comprises:
generating a random number within a predetermined numerical range based on the power-on being performed; and
providing the random number as the block indicator.

17. The operating method of claim 14, wherein generating the block indicator comprises:
generating a count value that is changed based on the power-on being performed within a predetermined numerical range
generating a random number within the predetermined numerical range based on the power-on being performed; and
providing any one of the count value and the random number to the block indicator.

18. The operating method of claim 14, further comprising:
extracting next video data blocks of the video data block that is indicated by the block indicator from next video frames of a video frame that is first provided among the video frames; and
updating the accumulative stress data sets of the corresponding display areas based on the extracted video data blocks.

19. A display system comprising:
a processor; and
a display device configured to receive video frames from the processor and to display a video based on the video frames,
wherein the display device includes:
a display panel including display areas;
a controller configured to control the display panel to display the video based on the video frames, each of the video frames including video data blocks corresponding to the display areas, respectively; and
an indicator generator configured to generate a block indicator having a value that is changed based on power-on being performed, and
wherein the controller is configured to: select the video data block that is indicated by the block indicator from the video data blocks of the video frame that is first provided among the video frames, and update an accumulative stress data set of the corresponding display area based on the selected video data block of the video frame.

20. The display system of claim 19, wherein the display system is one of a digital television (TV), a three-dimensional (3D) TV, a personal computer, a home appliance, a laptop computer, a table computer, a mobile phone, a smartphone, a personal digital assistant, a portable multimedia player, a digital camera, a music player, a portable game console, and a navigation device.
